(19) United States
(12) Patent Application Publication
(10) Pub. No.: US 2020/0175628 A1
(43) Pub. Date: Jun. 4, 2020

(54) SYSTEMS AND METHODS FOR PREDICTING WEATHER IMPACT ON AN AIRCRAFT

(71) Applicant: HONEYWELL INTERNATIONAL INC., Morris Plains, NJ (US)

(72) Inventors: Narayanan Srinivasan, Chennai (IN); Kiran Gopala Krishna, Bangalore (IN); Hariharan Saptharishi, Trichy (IN); Gobinathan Baladhandapani, Madurai (IN)

(73) Assignee: HONEYWELL INTERNATIONAL INC., Morris Plains, NJ (US)

(21) Appl. No.: 16/207,498

(22) Filed: Dec. 3, 2018

(51) Int. Cl. G06Q 50/26; G06F 16/2457

(52) U.S. Cl. CPC G06Q 50/265; G06F 16/24575

(57) ABSTRACT

Systems and methods for weather impact prediction are provided. The system receives current weather information and identifies a region along an intended flight path with a weather pattern of moderate or low severity. The system uses the identified region and aircraft identification to search a source of historical weather incidents to find a weather incident entry match, defined as a co-occurrence of a matching aircraft type, matching weather pattern, and matching severity rating. The match is evaluated for (i) structural damage, (ii) performance degradation, (iii) exterior damage, and (iv) inspection requirements, and a predicted weather impact report is generated for the identified region, the predicted weather impact report includes one or more of (i) structural damage, (ii) performance degradation, (iii) exterior damage, and (iv) inspection requirements. The system displays the predicted weather impact report.

### TECHNICAL FIELD

The technical field generally relates to navigational aids, and more particularly relates to systems and methods for predicting weather related impact on aircraft.

### BACKGROUND

A variety of weather events can have an undesirable effect on an aircraft. The weather events can impact the aircraft structure and/or aerodynamic performance. Non-limiting examples of weather events that can directly and indirectly affect aircraft performance include: turbulence, icing on various components of the aircraft, surface contamination of the surface an aircraft is operating on, precipitation, and lightening.

Deciding whether to continue to fly despite a weather event or to avoid the weather event is a difficult technical task because it involves anticipating or predicting aircraft performance, safety, and time factors. In addition to attempting to anticipate the type and severity of weather, a pilot must consider potential performance and structural impact, performance of on-board equipment, a pilot's experience, and available historical information. These disparate pieces of information are generally received from multiple different sources via multiple different communication devices and modalities. Processing this information can be additionally technically difficult due to a time pressure.

Accordingly, enhanced systems and methods that integrate information for the disparate sources and provide therefrom predictive information on which a pilot or crew may rely during decision making regarding a weather event are desirable. Technical effects of the desired system include the presentation of timely and relevant information in an easily comprehensible manner. The desired system increases pilot preparation and improves pilot-machine interface. The following disclosure provides these technological enhancements, in addition to addressing related issues.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one embodiment, a weather impact prediction system for an aircraft is provided. The system includes: a source of an intended flight path for the aircraft; a source of current weather information, the current weather information organized as regions, each region having a weather pattern, and each weather pattern having a severity rating of high, moderate, or low; a source of historical weather incidents; a source of aircraft specific parameters including an aircraft identification; and a weather impact prediction control module configured to: receive the current weather information; identify a region along the intended flight path with a weather pattern of moderate or low severity; using the identified region and aircraft identification, search the source of historical weather incidents to find a weather incident entry match, defined as a co-occurrence of a matching aircraft type, matching weather pattern, and matching severity rating; process the weather incident entry match to evaluate each of (i) structural damage, (ii) performance degradation, (iii) exterior damage, and (iv) inspection requirements; generate a predicted weather impact report for the identified region, the predicted weather impact report including one or more of (i) structural damage, (ii) performance degradation, (iii) exterior damage, and (iv) inspection requirements; and generate display commands for displaying alphanumeric information on a display system, the alphanumeric information including the predicted weather impact report.

In another provided embodiment of a weather impact prediction system for an aircraft, the system includes: a source of an intended flight path for the aircraft; a source of current weather information; a source of historical weather incidents; a source of aircraft specific parameters including an aircraft identification; and a weather impact prediction control module configured to: receive the current weather information; identify a region along the intended flight path with a weather pattern of moderate or low severity; using the identified region and aircraft identification, search the source of historical weather incidents to find a weather incident entry match, defined as a co-occurrence of a matching aircraft type, matching weather pattern, and matching severity rating; process the weather incident entry match to evaluate each of (i) structural damage, (ii) performance degradation, (iii) exterior damage, and (iv) inspection requirements; generate a predicted weather impact report for the identified region, the predicted weather impact report including one or more of (i) structural damage, (ii) performance degradation, (iii) exterior damage, and (iv) inspection requirements; and generate display commands for displaying alphanumeric information on a display system, the alphanumeric information including the predicted weather impact report.

In an embodiment, a processor executable method for weather impact prediction for an aircraft is provided. The method includes: receiving current weather information from a source of weather information; processing the current weather information with an intended flight path to identify a region along the intended flight path with a weather pattern of moderate or low severity; using the identified region and an aircraft identification to search a source of historical weather incidents to find a weather incident entry match, defined as a co-occurrence of a matching aircraft type, matching weather pattern, and matching severity rating; processing the weather incident entry match with aircraft specific data to evaluate each of (i) structural damage, (ii) performance degradation, (iii) exterior damage, and (iv) inspection requirements; generating a predicted weather impact report for the identified region, the predicted weather impact report including one or more of (i) structural damage, (ii) performance degradation, (iii) exterior damage, and (iv) inspection requirements; and generating display commands for displaying alphanumeric information on a display system, the alphanumeric information including the predicted weather impact report.

Furthermore, other desirable features and characteristics of the system and method will become apparent from the subsequent detailed description and the appended claims, taken in conjunction with the accompanying drawings and the preceding background.

### BRIEF DESCRIPTION OF THE DRAWINGS

The present application will hereinafter be described in conjunction with the following drawing figures, wherein like numerals denote like elements, and:

FIG. 1 is a block diagram of a weather impact prediction system for an aircraft, in accordance with an exemplary embodiment;

FIG. 2 is an image depicting the display of a predicted weather impact report, in accordance with an exemplary embodiment; and

FIG. 3 is a method for weather impact prediction, in accordance with an exemplary embodiment.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Thus, any embodiment described herein as “exemplary” is not necessarily to be construed as preferred or advantageous over other embodiments. The embodiments described herein are exemplary embodiments provided to enable persons skilled in the art to make or use the invention and not to limit the scope of the invention that is defined by the claims. Furthermore, there is no intention to be bound by any expressed or implied theory presented in the preceding technical field, background, summary, or the following detailed description.

As mentioned, a variety of weather events can directly and indirectly have an undesirable effect on the structure and/or aerodynamic performance of an aircraft. Weather events include weather patterns and weather-induced effects. Some non-limiting examples of weather events:

Weather Patterns:

Precipitation: for example, rain, hail, and snow affect aerodynamics and visibility.

Lightning: although a lightning strike can be a very distressing experience, structural damage to an aircraft from lightning very rarely threatens the safety of the aircraft. However, a lightning strike can affect avionics, particularly the compass and air-data systems. In rear-mounted jet engines with close spacing and shared airflow, a transient airflow associated with a lightning strike may potentially affect the jet engines at the same time and engine.

Turbulence: turbulence associated with convective activity (for example, thunderstorms), terrain (for example, the movement of air masses over mountains), jet streams and the interaction between air masses (for example polar fronts and associated dynamics), can be significant enough to cause structural damage to aircraft.

Weather Induced Effects:

Icing: ice and ice crystals can form on different components of the aircraft and alter the aerodynamic characteristics of an aircraft or may cause a loss of function of the engines. Further, ice may form on the aircraft prior to flight, which may be addressed by aircraft ground de/anti icing systems prior to becoming airborne.

Surface contamination: standing water, ice, or snow on take-off, landing, and maneuver surfaces.

A decision to fly or operate during a weather event or to avoid the weather event is a challenging task that requires evaluating a variety of disparate information in a short amount of time. Some of the parameters a pilot or crew evaluate include:
Type and severity of the weather event
Possible impact to aero dynamic structure (Icing on wings, Pitot blockage, etc.)
Possible impact to performance (such as turbulence, stall, tail rotor speed reduction, etc.)
Lifetime/age of the aircraft and the component which is going to be impacted
Standard operating procedure (SOP) adherence (Max Tail Wind speed while landing, etc.)
Experience/Historic Data
Requirements for flying though this weather (Anti-Skid brake in case of icing runway, availability of an instrument landing system in case of poor visibility, etc.)

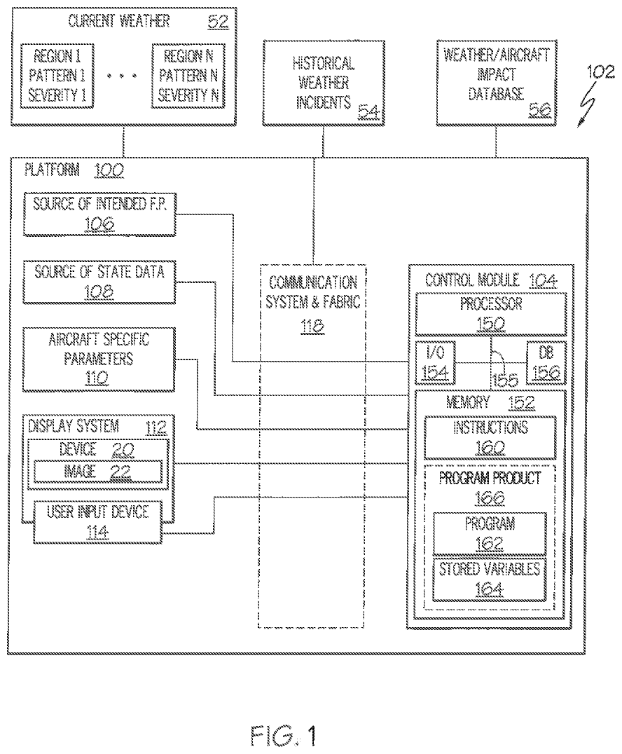

As may be appreciated, the pilot's preparation for upcoming weather events is crucial, and improving the pilot's preparation presents a technical problem in the form of developing enhanced tools and strategies. The proposed exemplary embodiments provide a technical solution to this problem in the form of a control module (FIG. 1, 104) embodying novel rules and parameters that integrate multiple considerations to increase a pilot or crew's preparedness for an upcoming weather event.

Exemplary embodiments receive and process weather data. The provided systems and methods process and integrate these inputs to convert them into useful information in a useful format for pilot consumption, which is a generated report of predicted weather impact. The predicted weather impact report provides information such as: a potential degradation of aircraft performance; a potential maintenance effort required at a next destination; and, a potential sequence of events if the aircraft is flown through the weather event considering the current status of the aircraft systems. The predicted weather impact report may be displayed in an intuitive and easy to uptake manner, enabling the pilot to assess or pay attention to weather variations and make safe decisions as to whether to fly through a weather event or to offset from the current flight path to avoid the weather event. The figures and descriptions below provide more detail.

Turning now to FIG. 1, in an embodiment, weather impact prediction system 102 (also referred to herein as “system” 102) is generally associated with a mobile platform 100. In various embodiments, the mobile platform 100 is an aircraft, and is referred to as aircraft 100. The system 102 embodies the control module 104. In some embodiments, the control module 104 may be integrated within a preexisting mobile platform management system, avionics system, cockpit display system (CDS), flight controls system (FCS), or aircraft flight management system (FMS). Although the control module 104 is shown as an independent functional block, onboard the aircraft 100, in other embodiments, it may exist in an electronic flight bag (EFB) or portable electronic device (PED), such as a tablet, cellular phone, or the like. In embodiments in which the control module is within an EFB or a PED, a display system 112 and user input device 114 may also be part of the EFB or PED.

The control module 104 may be operationally coupled to any combination of the following aircraft systems: a communication system and fabric 118; a source of an intended flight path 106, such as a navigation database (NavDB); a source of real-time aircraft state data 108, such as a navigation system; a source of aircraft-specific parameters 110; a source of current weather information 52; a source of historical weather incidents 54; and, a weather/aircraft impact database 56. Additionally, the system 102 may include a display system 112; and a user input device 114. The functions of these aircraft systems, and their interaction, are described in more detail below.

Real-time aircraft state data may include any of: an instantaneous location (e.g., the latitude, longitude, orientation), an instantaneous heading (i.e., the direction the aircraft is traveling in relative to some reference), a flight path angle, a vertical speed, a ground speed, an instantaneous altitude (or height above ground level), and a current phase of flight of the aircraft 100. As used herein, “real-time” is interchangeable with current and instantaneous. In some embodiments, the real-time aircraft state data is generated by a navigation system. The navigation system may be realized as including a global positioning system (GPS), inertial reference system (IRS), or a radio-based navigation system (e.g., VHF omni-directional radio range (VOR) or long-range aid to navigation (LORAN)), and may include one or more navigational radios or other sensors suitably configured to support operation of the FMS, as will be appreciated in the art. In various embodiments, the data referred to herein as the real-time aircraft state data may be referred to as navigation data, since it may be provided by a navigation system. The real-time aircraft state data is made available, generally by way of the communication system and fabric 118, so other components, such as the control module 104 and the display system 112, may further process and/or handle the aircraft state data.

An intended flight path may include a series of intended geospatial midpoints between a departure and an arrival, as well as performance data associated with each of the geospatial midpoints (non-limiting examples of the performance data include intended navigation data, such as: intended airspeed, intended altitude, intended acceleration, intended flight path angle, and the like). As such, the intended flight path may be part of an operational flight plan (OFP). A source of the intended flight path 106 may be a storage location or a user input device. In various embodiments, a navigation database, NavDB, is the source of the active trajectory or OFP. The NavDB is generally a storage location that may also maintain a database of flight plans, and/or information regarding terrain and airports and/or other potential landing locations (or destinations) for the aircraft 100.

The source of aircraft-specific parameters 110 generally provides, for each of a variety of aircraft 100 subsystems, current status and performance data. Examples of aircraft-specific parameters include: engine thrust level, fuel level, flap configuration, braking status, temperature control system status, and the like. In an example, the aircraft system may be landing gear, and its status may be an inefficiency, such as, that it is non-retracting. As may be appreciated, the source of aircraft-specific parameters 110 may therefore include a variety of components, such as on-board detection sensors, which may be operationally coupled to the control module 104, central management computer, or FMS.

In various embodiments, a communications system and fabric 118 is configured to support instantaneous (i.e., real time or current) communications between on-board systems (i.e., the source of the intended flight path 106, the source of aircraft state data 108, the source of aircraft-specific parameters 110, and the display system 112), the control module 104, and the one or more external data source(s), such as the source of current weather information 52, the source of historical weather incidents 54, and the weather/aircraft impact database 56. As a functional block, the communications system and fabric 118 represents one or more transmitters, receivers, and the supporting communications hardware and software required for components of the system 102 to communicate as described herein. In various embodiments, the communications system and fabric 118 may have additional communications not directly relied upon herein, such as bidirectional pilot-to-ATC (air traffic control) communications via a datalink; support for an automatic dependent surveillance broadcast system (ADS-B); a communication management function (CMF) uplink; a terminal wireless local area network (LAN) unit (TWLU); an instrument landing system (ILS); and, any other suitable radio communication system that supports communications between the aircraft 100 and the various external source(s). In various embodiments, the control module 104 and communications system and fabric 118 also support the herein referenced controller pilot data link communications (CPDLC), such as through an aircraft communication addressing and reporting system (ACARS) router; in various embodiments, this feature may be referred to as a communications management unit (CMU) or communications management function (CMF). In summary, the communications system and fabric 118 may allow the aircraft 100 and the control module 104 to receive information that would otherwise be unavailable to the pilot and/or co-pilot using only the onboard systems.

The source of current weather information 52 may include weather radar, a source for meteorological terminal aviation weather reports (METARS), and the like. The current weather information is generally organized as a plurality (N) of regions, each region having an associated weather pattern, and each weather pattern having a corresponding severity rating, for example, high (also referred to as severe), moderate, low (also referred to as minor), and none. The severity rating is the one defined by the Federal Aviation Administration related to weather radar. The current weather information may be organized in this manner before being transmitted onboard the aircraft 100 or may be organized this way by the control module 104 prior to further processing described below. In some embodiments, the source of current weather information 52 is external to the aircraft 100, and in other embodiments, the source of current weather information 52 is on-board the aircraft 100.

The source of historical weather incidents 54 represents one or more publicly sharable websites and databases that provide a plurality of collected weather incident reports, collected over time, and collected by various agencies. The entries generally include catalogued information such as, an aircraft type (make and model), weather event exposed to, and resulting actual impact.

In contrast, the weather/aircraft impact database 56 is specific to aircraft 100 (identification and type) and, over time, becomes populated with, for each weather event that the aircraft 100 has endured, a predicted impact and an actual weather impact, as well as aircraft 100 age and corresponding inspections and maintenance schedules. The contents of the weather/aircraft impact database 56 may be shared or may be kept as proprietary information for the owner of the aircraft 100. The actual weather impact on the specific aircraft 100 resulting from flying through that specific weather pattern and severity can be obtained via an aircraft inspection performed after the aircraft 100 has landed and then recorded and stored. This information may also be shared with, or stored, in the source of historical weather incidents 54.

The user input device 114 and the control module 104 are cooperatively configured to allow a user (e.g., a pilot, co-pilot, or crew member) to interact with display devices 20 in the display system 112 and/or other elements of the system 102, as described in greater detail below. Depending on the embodiment, the user input device 114 may be realized as a cursor control device (CCD), keypad, touchpad, keyboard, mouse, touch panel (or touchscreen), joystick, knob, line select key, voice controller, gesture controller, or another suitable device adapted to receive input from a user. When the user input device 114 is configured as a touchpad or touchscreen, it may be integrated with the display system 112. As used herein, the user input device 114 may be used by a pilot to communicate with external sources, such as ATC, to modify or upload the program product 166, etc. In various embodiments, the display system 112 and user input device 114 are onboard the aircraft 100 and are also operationally coupled to the communication system and fabric 118. In some embodiments, the control module 104, user input device 114, and display system 112 are configured as a control display unit (CDU).

In various embodiments, the control module 104, alone, or as part of a central management computer (CMS) or a flight management system (FMS), draws upon data and information from the source of intended flight path 106 and source of aircraft state data 108 to provide real-time flight guidance for aircraft 100. The real time flight guidance may be provided to a user by way of images 22 on the display system 112, audible emissions from an audio system, or the like. For example, the control module 104 may compare an instantaneous position and heading of the aircraft 100 with the operational flight plan data for the aircraft 100 and generate display commands to render images 22 showing these features and distinguishing them from each other. The control module 104 may further provide flight guidance responsive to associating a respective airport, its geographic location, runways (and their respective orientations and/or directions), instrument procedures (e.g., approach procedures, arrival routes and procedures, takeoff procedures, and the like), airspace restrictions, and/or other information or attributes associated with the respective airport (e.g., widths and/or weight limits of taxi paths, the type of surface of the runways or taxi path, and the like) with the instantaneous position and heading of the aircraft 100 and/or with the intended flight plan for the aircraft 100.

The control module 104 may perform display processing. In various embodiments, the control module 104 generates display commands for the display system 112 to cause the display device 20 to render thereon the image 22, comprising various graphical user interface elements, tables, icons, alerts, menus, buttons, and pictorial images, as described herein. The display system 112 is configured to continuously receive and process the display commands from the control module 104. The display system 112 includes a display device 20 for presenting an image 22. In various embodiments described herein, the display system 112 includes a synthetic vision system (SVS), and the image 22 is a SVS image. In exemplary embodiments, the display device 20 is realized on one or more electronic display devices, such as a multi-function display (MFD) or a multi-function control display unit (MCDU), configured as any combination of: a head up display (HUD), an alphanumeric display, a vertical situation display (VSD) and a lateral navigation display (ND).

The control module 104 may perform graphical processing. Responsive to display commands, renderings on the display system 112 may be processed by a graphics system, components of which may be integrated into the display system 112 and/or be integrated within the control module 104. Display methods include various types of computer generated symbols, text, and graphic information representing, for example, pitch, heading, flight path, airspeed, altitude, runway information, waypoints, targets, obstacles, terrain, and required navigation performance (RNP) data in an integrated, multi-color or monochrome form. Display methods also include various formatting techniques for visually distinguishing objects and routes from among other similar objects and routes. The control module 104 may be said to display various images and selectable options described herein. In practice, this may mean that the control module 104 generates display commands, and, responsive to receiving the display commands from the control module 104, the display system 112 displays, renders, or otherwise visually conveys on the display device 20, the graphical images associated with operation of the aircraft 100, and specifically, the graphical images as directed by the control module 104. In various embodiments, any combination of the control module 104, user input device 114, source of aircraft specific parameters 110, and communication system and fabric 118, may be coupled to the display system 112 such that the display system 112 may additionally generate or render, on the display device 20, real-time information associated with respective aircraft 100 systems and components.

The control module 104 performs the functions of the system 102. As used herein, the term “module” refers to any means for facilitating communications and/or interaction between the elements of the system 102 and performing additional processes, tasks and/or functions to support operation of the system 102, as described herein. In various embodiments, the control module 104 may be any hardware, software, firmware, electronic control component, processing logic, and/or processor device, individually or in any combination. Depending on the embodiment, the control module 104 may be implemented or realized with a general purpose processor (shared, dedicated, or group) controller, microprocessor, or microcontroller, and memory that executes one or more software or firmware programs; a content addressable memory; a digital signal processor; an application specific integrated circuit (ASIC), a field programmable gate array (FPGA); any suitable programmable logic device; combinational logic circuit including discrete gates or transistor logic; discrete hardware components and memory devices; and/or any combination thereof, designed to perform the functions described herein.

Accordingly, in FIG. 1, an embodiment of the control module 104 is depicted as an enhanced computer system comprising a processor 150 and a memory 152. The processor 150 may comprise any type of processor or multiple processors, single integrated circuits such as a microprocessor, or any suitable number of integrated circuit devices and/or circuit boards working in cooperation to carry out the described operations, tasks, and functions by manipulating electrical signals representing data bits at memory locations in the system memory, as well as other processing of signals. The memory 152 may comprise RAM memory, ROM memory, flash memory, registers, a hard disk, or another suitable non-transitory short or long-term storage media capable of storing computer-executable programming instructions or other data for execution. The memory 152 may be located on and/or co-located on the same computer chip as the processor 150. Generally, the memory 152 maintains data bits and may be utilized by the processor 150 as storage and/or a scratch pad during operation. Specifically, the memory 152 stores instructions and applications 160. Information in the memory 152 may be organized and/or imported from an external source 50 during an initialization step of a process; it may also be programmed via a user input device 114. During operation, the processor 150 loads and executes one or more programs, algorithms and rules embodied as instructions and applications 160 contained within the memory 152 and, as such, controls the general operation of the control module 104 as well as the system 102.

The novel program 162 includes rules and instructions which, when executed, convert the processor 150/memory 152 configuration into the control module 104, which is a novel and enhanced “weather impact prediction” control module that performs the functions, techniques, and processing tasks associated with the operation of the system 102. Novel program 162 and associated stored variables 164 may be stored in a functional form on computer readable media, for example, as depicted, in memory 152. While the depicted exemplary embodiment of the control module 104 is described in the context of a fully functioning computer system, those skilled in the art will recognize that the mechanisms of the present disclosure are capable of being distributed as a program product 166.

As a program product 166, one or more types of non-transitory computer-readable signal bearing media may be used to store and distribute the program 162, such as a non-transitory computer readable medium bearing the program 162 and containing therein additional computer instructions for causing a computer processor (such as the processor 150) to load and execute the program 162. Such a program product 166 may take a variety of forms, and the present disclosure applies equally regardless of the type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized as memory 152 and as program product time-based viewing of clearance requests in certain embodiments.

In various embodiments, the processor/memory unit of the control module 104 may be communicatively coupled (via a bus 155) to an input/output (I/o) interface 154, and a database 156. The bus 155 serves to transmit programs, data, status and other information or signals between the various components of the control module 104. The bus 155 can be any suitable physical or logical means of connecting computer systems and components. This includes, but is not limited to, direct hard-wired connections, fiber optics, infrared and wireless bus technologies.

The I/O interface 154 enables intra control module 104 communication, as well as communications between the control module 104 and other system 102 components, and between the control module 104 and the external data sources via the communication system and fabric 118. The I/O interface 154 may include one or more network interfaces and can be implemented using any suitable method and apparatus. In various embodiments, the I/O interface 154 is configured to support communication from an external system driver and/or another computer system. In one embodiment, the I/O interface 154 is integrated with the communication system and fabric 118 and obtains data from external data source(s) directly. Also, in various embodiments, the I/O interface 154 may support communication with technicians, and/or one or more storage interfaces for direct connection to storage apparatuses, such as the database 156.

In some embodiments, the database 156 is part of the memory 152. In various embodiments, the database 156 and the source of historical weather incidents 54 and/or the weather/aircraft impact database 56 are integrated, either within the control module 104 or external to it. Additionally, in some embodiments, airport features data and terrain features are pre-loaded and internal to the control module 104.

The novel control module 104 may perform the functions of weather impact prediction as related to aircraft structures, systems, and performance. In executing these functions, the processor 150 specifically loads the instructions embodied in the program 162, thereby being programmed with program 162. During execution of program 162, the processor 150, the memory 152, and the database DB 156 form a novel weather impact prediction processing engine that performs the functions and tasks of the system 102.

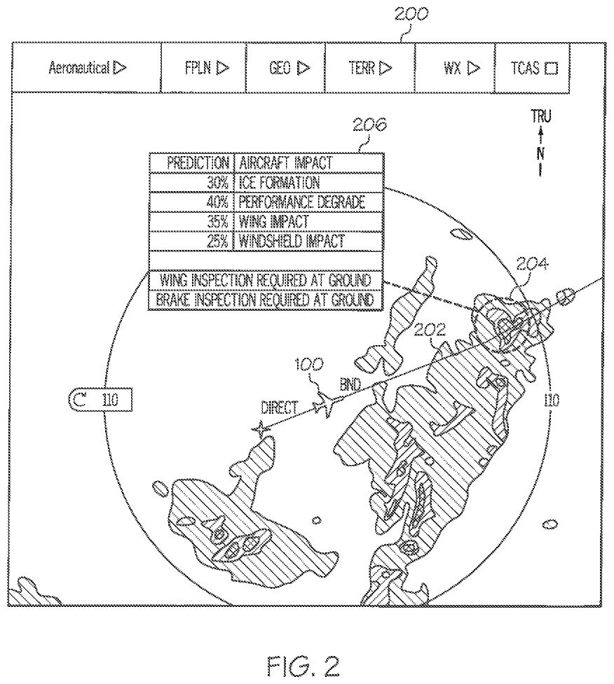

FIG. 2 is an exemplary top-down or lateral image 200 that may be displayed on a display device 20, such as a primary flight display (PFD), in accordance with the embodiments provided herein. Aircraft 100 is following an intended flight path 202. Current weather information is continuously received. The system 102 processes received current weather information to identify a region 204 along the intended flight path 202, and then further references databases and processes received inputs to evaluate each of: (i) structural damage, (ii) performance degradation, (iii) exterior damage, and (iv) inspection requirements, should the aircraft 100 fly through the identified weather pattern. Based on the evaluation, the system 102 generates the predicted weather impact report, which comprises one or more entries of (i) structural damage, (ii) performance degradation, (iii) exterior damage, and (iv) inspection requirements. It also predicts a likelihood of each entry. When there are a plurality (N) of identified regions along or nearby the intended flight path 202, the system 102 processes each region of the N regions and a respective predicted weather impact report is generated. The predicted weather impact report 206 is displayed as an overlay on the lateral image 200.

Data in the predicted weather impact report 206 can be organized in a variety of formats. In various embodiments, the data is arranged in a tabular format. Each row in the table itemizes a different predicted aircraft impact item, with an associated predicated percentage likelihood for the aircraft impact item. For example, the predicted weather impact report 206 indicates a 30% chance of ice formation, a 40% chance of engine performance degradation, a 35% chance of an impact to a wing, and a 25% chance of a windshield impact. The predicted weather impact report 206 may also include maintenance and inspection advice. For example, the predicted weather impact report 206 includes entries advising that a wing inspection will be required at ground, and a brake inspection will be required at ground. When multiple reports are generated, a pilot or crew may click on each of them (i.e., with the user input device 114 or a touch screen) and the system 102 will, responsive to the user input, bring them forward, minimize, and/or enlarge them.

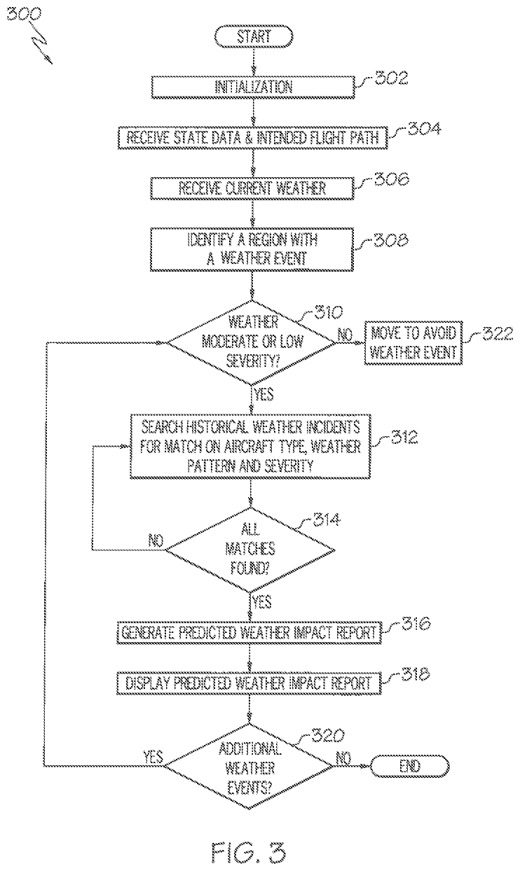

The system 102 may make its determinations and selections in accordance with a method such as method 300 of FIG. 3. With continued reference to FIGS. 1-2, a flow chart is provided for a method 300 for providing a system 102, in accordance with various exemplary embodiments. Method 300 represents various embodiments of a for weather impact prediction. For illustrative purposes, the following description of method 300 may refer to elements mentioned above in connection with FIG. 1. In practice, portions of method 300 may be performed by different components of the described system. It should be appreciated that method 300 may include any number of additional or alternative tasks, the tasks shown in FIG. 3 need not be performed in the illustrated order, and method 300 may be incorporated into a more comprehensive procedure or method having additional functionality not described in detail herein. Moreover, one or more of the tasks shown in FIG. 3 could be omitted from an embodiment of the method 300 if the intended overall functionality remains intact.

The method starts, and at 302 the control module 104 is initialized and the system 102 is in operation. Initialization may comprise uploading or updating instructions and applications 160, program 162, lookup tables, and formatting instructions that may be stored in the database 156. Stored variables may include, for example, configurable, predetermined margins of distance around the flight path to consider in the weather analysis, parameters for setting up a user interface, and the various shapes, various colors and/or visually distinguishing techniques used for the predicted weather impact report 206, and related icons and alerts. In some embodiments, program 162 includes additional instructions and rules for rendering information differently based on type of display device in display system 112. Initialization at 302 may also include identifying external sources and/or external signals and the communication protocols to use with each external source.

At 304, aircraft state data and an intended flight path is received. At 306, the current weather information is received. As may be appreciated, the display system 112 continuously updates the lateral image 22 to indicate the aircraft 100 at its current position and with weather imagery based on received data. At 308, a region having a weather event that is located along the intended flight path 202 is identified. At 310, the method parses the region information for the weather pattern and its corresponding severity. Examples of weather patterns include rain, sleet, turbulence, wind, and the like. When the severity rating of the weather pattern in region 204 is severe, the pilot will not consider flying into it; the system 102 may jump to another procedure at 322 for altering the flight path to avoid the region. If the weather pattern has a severity rating of moderate or low (or the equivalent on another scale) at 310, the method proceeds to 312. At 312, the method references aircraft specific parameters to obtain an aircraft identification including an aircraft type. In various embodiments, the aircraft type is the equivalent of a make and model number. The method searches entries in the source of historical weather incidents 54 to find a weather incident entry match. A weather incident entry match is an entry that matches, concurrently, the following: same aircraft type, same weather pattern, and same severity rating. In various embodiments, at 312, the method 300 also searches for matching entries in the weather/aircraft impact database 56, which is the historical weather impact information that is specific (i.e., unique) to the aircraft 100. At 312, when a weather incident entry match has been found, the method 300 may continue searching the entries in the source of historical weather incidents 54 until all weather incident entry matches are found at 314.

At 316, a predicted weather impact report 206 is generated. In order to generate the predicted weather impact report 206, the method 300 processes the one or more weather incident entry matches to evaluate each of: (i) structural damage, (ii) performance degradation, (iii) exterior damage, and (iv) inspection requirements; and, based thereon, generates the predicted weather impact report 206 comprising one or more of (i) structural damage, (ii) performance degradation, (iii) exterior damage, and (iv) inspection requirements. As alluded to, in generating the predicted weather impact report 206, the system 102 also processes data from the source of aircraft specific parameters 110 (providing the current status and age of individual aircraft systems). In the example above, the aircraft system was a non-retracting landing gear; accordingly, the system 102 may determine that the non-retracting landing gear is safe to operate through a moderate turbulence event, and the predicted weather impact report 206 has integrated this information.

When, as a result of 312 and 314, the weather incident entry match is one of a plurality of weather incident entry matches, the method 300 and the control module 104 further, for each of the plurality of weather incident entry matches, processes the weather incident entry match to evaluate each of (i) structural damage, (ii) performance degradation, (iii) exterior damage, and (iv) inspection requirements; and generates the predicted weather impact report 206 based on the processing of the plurality of weather incident entry matches.

As stated, at 316, a predicted weather impact report 206 is generated for the region. As may be appreciated, the predicted weather impact report 206 represents comparing, for one or more aircraft of the same type as aircraft 100, a component to a same component and a system to a same system from all matching entries found at 312; these comparisons are integrated and synthesized, thereby converting the data into a more useful form than previously available for the pilot to consider. At 318, the predicted weather impact report 206 is displayed, and at 320, the method 300 checks for additional weather events that are along the flight path. When additional weather events are found, the method may return to 310. When no other weather events are found, the method may end or proceed to additional processing.

Additional processing may occur after the aircraft 100 lands. At that time, an aircraft inspection may be performed to generate an actual weather impact report on the specific aircraft 100 (identification and type) resulting from flying through that specific weather pattern and severity. The actual weather impact report can be recorded and stored. The system 102 may receive the actual weather impact report, associate it with the predicted weather impact report and store the associated reports in the source of historical weather incidents 54; and in various embodiments, it may be stored in the weather/aircraft impact database 56. Differences between the actual weather impact report and the predicted weather impact report are processed in subsequent cycles through the method 300 and this continually improves the system 102 and the method 300.

Thus, technologically improved systems and methods that provide weather impact prediction are provided. The system 102 identifies a region along an intended flight path with a weather pattern of moderate or low severity and uses the identified region information and an aircraft identification to search a source of historical weather incidents to generate weather impact predictions to aircraft structure and performance should the aircraft fly through the identified weather pattern.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate the interchangeability of hardware and software, various illustrative components, blocks, modules, circuits, and steps have been described above generally in terms of their functionality. Whether such functionality is implemented as hardware or software depends upon the application and design constraints imposed on the overall system.

Skilled artisans may implement the described functionality in varying ways for each application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

Further, the various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of the method or algorithm described in connection with the embodiments disclosed herein may be embodied directly in hardware, in a software module executed by a controller or processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. When “or” is used herein, it is the logical or mathematical or, also called the “inclusive or.” Accordingly, A or B is true for the three cases: A is true, B is true, and, A and B are true. In some cases, the exclusive “or” is constructed with “and;” for example, “one from A and B” is true for the two cases: A is true, and B is true.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A weather impact prediction system for an aircraft, the system comprising:
a source of an intended flight path for the aircraft;
a source of current weather information, the current weather information organized as regions, each region having a weather pattern, and each weather pattern having a severity rating of high, moderate, or low;
a source of historical weather incidents;
a source of aircraft specific parameters including an aircraft identification; and
a weather impact prediction control module configured to:
receive the current weather information;
identify a region along the intended flight path with a weather pattern of moderate or low severity;
using the identified region and aircraft identification, search the source of historical weather incidents to find a weather incident entry match, defined as a co-occurrence of a matching aircraft type, matching weather pattern, and matching severity rating;
process the weather incident entry match to evaluate each of (i) structural damage, (ii) performance degradation, (iii) exterior damage, and (iv) inspection requirements;
generate a predicted weather impact report for the identified region, the predicted weather impact report comprising one or more of (i) structural damage, (ii) performance degradation, (iii) exterior damage, and (iv) inspection requirements; and
generate display commands for displaying alphanumeric information on a display system, the alphanumeric information including the predicted weather impact report.

2. The system of claim 1, wherein the weather incident entry match is one of a plurality of weather incident entry matches, and wherein the weather impact prediction control module is further configured to:
for each of the plurality of weather incident entry matches, process the weather incident entry match to evaluate each of (i) structural damage, (ii) performance degradation, (iii) exterior damage, and (iv) inspection requirements; and
generate the predicted weather impact report for the identified region based on the processing of the plurality of weather incident entry matches.

3. The system of claim 2, further comprising a display system configured to receive the display commands and render the predicted weather impact report on an image responsive to the display commands.

4. The system of claim 3, wherein the weather incident entry match is one of a plurality of weather incident entry matches, and the weather impact prediction control module is further configured to:
for each of the plurality of weather incident entry matches, process the weather incident entry match to evaluate each of (i) structural damage, (ii) performance degradation, (iii) exterior damage, and (iv) inspection requirements; and
generate the predicted weather impact report based on the processing of the plurality of weather incident entry matches.

5. The system of claim 4, wherein the weather impact prediction control module is further configured to:
receive an actual weather impact report;
associate the predicted weather impact report with the actual weather impact report; and
store the associated reports in the source of historical weather incidents.

6. The system of claim 5, further comprising a weather/aircraft impact database, and wherein the weather impact prediction control module is further configured to:
using the identified region and aircraft identification, search the weather/aircraft impact database to find a second weather incident entry match;
process the second weather incident entry match to evaluate each of (i) structural damage, (ii) performance degradation, (iii) exterior damage, and (iv) inspection requirements; and
generate the predicted weather impact report further based on the second weather incident entry match.

7. The system of claim 6, wherein the weather impact prediction control module is further configured to store the associated reports in the weather/aircraft impact database.

8. The system of claim 7, wherein the weather impact prediction control module is further configured to organize the one or more of (i) structural damage, (ii) performance degradation, (iii) exterior damage, and (iv) inspection requirements into a table that is overlaid on a lateral image.

9. A weather impact prediction system for an aircraft, the system comprising:
a source of an intended flight path for the aircraft;
a source of current weather information;
a source of historical weather incidents;
a source of aircraft specific parameters including an aircraft identification; and
a weather impact prediction control module configured to:
receive the current weather information;
identify a region along the intended flight path with a weather pattern of moderate or low severity;
using the identified region and aircraft identification, search the source of historical weather incidents to find a weather incident entry match, defined as a co-occurrence of a matching aircraft type, matching weather pattern, and matching severity rating;
process the weather incident entry match to evaluate each of (i) structural damage, (ii) performance degradation, (iii) exterior damage, and (iv) inspection requirements;
generate a predicted weather impact report for the identified region, the predicted weather impact report comprising one or more of (i) structural damage, (ii) performance degradation, (iii) exterior damage, and (iv) inspection requirements; and
generate display commands for displaying alphanumeric information on a display system, the alphanumeric information including the predicted weather impact report.

10. The system of claim 9, wherein the weather incident entry match is one of a plurality of weather incident entry matches, and wherein the weather impact prediction control module is further configured to:
for each of the plurality of weather incident entry matches, process the weather incident entry match to evaluate each of (i) structural damage, (ii) performance degradation, (iii) exterior damage, and (iv) inspection requirements; and
generate the predicted weather impact report for the identified region based on the processing of the plurality of weather incident entry matches.

11. The system of claim 9, wherein the weather impact prediction control module is further configured to organize the one or more of (i) structural damage, (ii) performance degradation, (iii) exterior damage, and (iv) inspection requirements into a table that is overlaid on a lateral image.

12. The system of claim 9, further comprising a weather/aircraft impact database, and wherein the weather impact prediction control module is further configured to:
using the identified region and aircraft identification, search the weather/aircraft impact database to find a second weather incident entry match;
process the second weather incident entry match to evaluate each of (i) structural damage, (ii) performance degradation, (iii) exterior damage, and (iv) inspection requirements; and
generate the predicted weather impact report further based on the second weather incident entry match.

13. The system of claim 9, wherein the weather impact prediction control module is further configured to:
receive an actual weather impact report;
associate the predicted weather impact report with the actual weather impact report; and
store the associated reports in the source of historical weather incidents.

14. The system of claim 9, further comprising a weather/aircraft impact database, and wherein the weather impact prediction control module is further configured to:
using the identified region and aircraft identification, search the weather/aircraft impact database to find a second weather incident entry match;
process the second weather incident entry match to evaluate each of (i) structural damage, (ii) performance degradation, (iii) exterior damage, and (iv) inspection requirements; and
generate the predicted weather impact report further based on the second weather incident entry match.

15. The system of claim 14, wherein the weather impact prediction control module is further configured to:
receive an actual weather impact report;
associate the predicted weather impact report with the actual weather impact report; and
store the associated reports in the weather/aircraft impact database.

16. A processor executable method for weather impact prediction for an aircraft, comprising:
receiving current weather information from a source of weather information;
processing the current weather information with an intended flight path to identify a region along the intended flight path with a weather pattern of moderate or low severity;
using the identified region and an aircraft identification to search a source of historical weather incidents to find a weather incident entry match, defined as a co-occurrence of a matching aircraft type, matching weather pattern, and matching severity rating;
processing the weather incident entry match with aircraft specific data to evaluate each of (i) structural damage, (ii) performance degradation, (iii) exterior damage, and (iv) inspection requirements;
generating a predicted weather impact report for the identified region, the predicted weather impact report comprising one or more of (i) structural damage, (ii) performance degradation, (iii) exterior damage, and (iv) inspection requirements; and
generating display commands for displaying alphanumeric information on a display system, the alphanumeric information including the predicted weather impact report.

17. The method of claim 16, wherein the weather incident entry match is one of a plurality of weather incident entry matches, further comprising:
for each of the plurality of weather incident entry matches, processing the weather incident entry match to evaluate each of (i) structural damage, (ii) performance degradation, (iii) exterior damage, and (iv) inspection requirements; and
generating the predicted weather impact report for the identified region based on the processing of the plurality of weather incident entry matches.

18. The method of claim 17, further comprising:
receiving an actual weather impact report;
associating the predicted weather impact report with the actual weather impact report; and
storing the associated reports in the source of historical weather incidents.

19. The method of claim 18, further comprising:
searching a weather/aircraft impact database using the identified region and an aircraft identification to find a second weather incident entry match;
processing the second weather incident entry match to evaluate each of (i) structural damage, (ii) performance degradation, (iii) exterior damage, and (iv) inspection requirements; and
generating the predicted weather impact report further based on the second weather incident entry match.

20. The method of claim 19, further comprising storing the associated reports in the weather/aircraft impact database.
